(19) United States
(12) Patent Application Publication
(10) Pub. No.: US 2010/0230979 A1
(43) Pub. Date: Sep. 16, 2010

(54) Doorway Having a Recessed Magnetic Lock

(76) Inventor: Ulysses E. Gries, Milwaukee, WI (US)

Correspondence Address: QUARLES & BRADY LLP, 411 E. WISCONSIN AVENUE, SUITE 2040, MILWAUKEE, WI, 53202-4497, US

(21) Appl. No.: 12/723,213

(22) Filed: Mar. 12, 2010

Related U.S. Application Data
(60) Provisional application No. 61/160,531, filed on Mar. 16, 2009.

(51) Int. Cl. E05C 19/16; E06B 1/12

(52) U.S. Cl. 292/251.5; 52/204.1

(57) ABSTRACT

A doorway having a recessed magnetic lock is disclosed. The doorway that comprises a jamb that defines an interior jamb space. The jamb includes a stop surface that defines a jamb opening between the interior jamb space and an exterior space. The doorway further comprises an electromagnet housed within the interior jamb space that is operable to provide an attractive magnetic force. The doorway further comprises a door pivotally connected to the jamb to open and close the doorway. The door defines an interior door space and includes a front surface. The front surface defines a door opening between the interior door space and the exterior space. The doorway further comprise a magnetically attractive armature housed within the interior door space. The armature is abuttingly engagable with the electromagnet when the doorway is closed.

### CROSS-REFERENCE TO RELATED APPLICATION

This claims the benefit of the filing date of U.S. Provisional Patent Application No. 61/160,531 filed Mar. 16, 2009, the entire disclosure of which is hereby incorporated for all purposes.

### STATEMENT CONCERNING FEDERALLY SPONSORED RESEARCH OR DEVELOPMENT

Not applicable.

### FIELD OF THE INVENTION

This invention relates to magnetic locks for doorways, and more particularly to abutting-type magnetic locks.

### BACKGROUND OF THE INVENTION

Magnetic locks are widely used in different fields to secure various types of entryways, such as gates, doors, and the like. These locks can resist forces comparable to those of conventional mechanical locks and offer a number of other advantages over mechanical locks; for example, magnetic locks can be more reliable than mechanical locks because they include few moving parts, if any. That is, magnetic locks do not use parts similar to those of conventional locks, such as pins, springs, and cams. Instead, magnetic lock designs typically include a fixed electromagnet connected to the door frame or jamb that provides an attractive magnetic force when electrically energized by a power source. The electromagnet attracts and holds a magnetically attractive armature fixed to the door thereto, thereby securing the door to the jamb.

Magnetic locks, while being effective substitutes for mechanical locks, include several disadvantages. For example, magnetic locks are typically manufactured separately from doorways on which they are used, and magnetic locks are not typically considered when designing a doorway. As a result, most magnetic locks are installed such that the electromagnet extends from the jamb inwardly to the entryway. These designs are sometimes struck by objects passing through the doorway, and adjustments are then needed to ensure proper lock function. In addition, designs with exposed electromagnets typically include exposed wiring that can catch on objects or permit tampering to disable the magnetic lock. Further still, the electromagnet, the armature, or both components form horizontal ledges on which dust can collect and cause cleaning difficulties; this is especially problematic if the doorway is used in a “clean” environment, such as those of some laboratories.

An end user needs to perform a substantial amount of labor or enlist a technician to install a doorway with a conventional magnetic lock. First, the jamb, door, and hinge must be mounted accurately to ensure proper motion of the door. Next, several holes must be carefully marked and drilled to attach the electromagnet and the armature on the doorway. After installation, the end user or technician may have to adjust the magnetic lock components to ensure proper lock function.

Considering the limitations of previous magnetic lock designs, a need exists for a doorway having a recessed magnetic lock in which the amount of labor required by the end user is reduced. A need also exists for such a doorway to be less susceptible to tampering and contact with objects passing through the doorway. Further still, a need exists for such a doorway to provide a cleanable ledge-free door assembly.

### SUMMARY OF THE INVENTION

In one aspect, the present invention provides a doorway that comprises a jamb that defines an interior jamb space. The jamb includes a stop surface that defines a jamb opening between the interior jamb space and an exterior space. The doorway further comprises an electromagnet housed within the interior jamb space that is operable to provide an attractive magnetic force. The doorway further comprises a door pivotally connected to the jamb to open and close the doorway. The door defines an interior door space and includes a front surface. The front surface defines a door opening between the interior door space and the exterior space. The doorway further comprise a magnetically attractive armature housed within the interior door space. The armature is abuttingly engagable with the electromagnet when the doorway is closed.

In another aspect of the invention, the doorway comprises a jamb that includes a stop surface and an electromagnet housed within the jamb that is operable to provide an attractive magnetic force. The electromagnet includes an exposed face being one of recessed in the jamb and flush with the stop surface. The doorway further comprises a door pivotally connected to the jamb to open and close the doorway, and the door includes a front surface that is engagable with the stop surface to close the doorway. The doorway further comprises a magnetically attractive armature housed within the door. The armature includes an exposed face that is abuttingly engagable with the electromagnet when the doorway is closed. The exposed face is one of recessed in the door and flush with the front surface.

In yet another aspect of the invention, the doorway comprises a jamb that defines an interior jamb space and includes a stop surface. The stop surface defines a jamb opening between the interior jamb space and an exterior space. The doorway further comprises a door that is pivotally connected to the jamb to open and close the doorway. The door defines an interior door space and includes a front surface that is engagable with the stop surface to close the doorway. The stop surface defines a door opening between the interior door space and the exterior space. The doorway further comprises a magnetic lock that includes an electromagnet disposed within the interior jamb space that is operable to provide an attractive magnetic force. The electromagnet includes an exposed face nearest the exterior space that faces a direction in which individuals pass through the doorway. The exposed face is one of recessed in the interior jamb space and flush with the stop surface. The magnetic lock further includes a magnetically attractive armature disposed within the interior door space configured to engage the electromagnet. The armature further includes an exposed face nearest the exterior space that faces opposite the direction faced by the electromagnet when the doorway is closed. The exposed face of the armature is one of recessed in the interior door space and flush with the front surface.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

The invention will hereafter be described with reference to the accompanying drawings, wherein like reference numerals denote like elements, and:

FIG. 1 is a perspective view of a doorway of the present invention with the door open;

FIG. 2 is a front view of the doorway of FIG. 1 with the door closed;

FIG. 3 is a side sectional view taken along line 3-3 of FIG. 2;

FIG. 4 is a top sectional view taken along line 4-4 of FIG. 2;

FIG. 5 is a partial front view of a jamb of the doorway of FIG. 1;

FIG. 6 is a partial front view of the door of FIG. 1;

FIG. 7 is a perspective view of a magnetic lock of the doorway of FIG. 1 separate from the other components;

FIG. 8 is a partial front view of an embodiment of the doorway including a door closer; and

FIG. 9 is a partial rear view of the embodiment of the doorway of FIG. 8 with the door closed.

### DETAILED DESCRIPTION OF THE PREFERRED EMBODIMENT

The particulars shown herein are by way of example and only for purposes of illustrative discussion of the embodiments of the invention. The particulars shown herein are presented to provide what is believed to be the most useful and readily understood description of the principles and conceptual aspects of the invention. In this regard, no attempt is made to show structural details of the invention in more detail than is necessary for the fundamental understanding of the invention. The description taken with the drawings and photographs should make apparent to those skilled in the art how the several forms of the present invention may be embodied in practice.

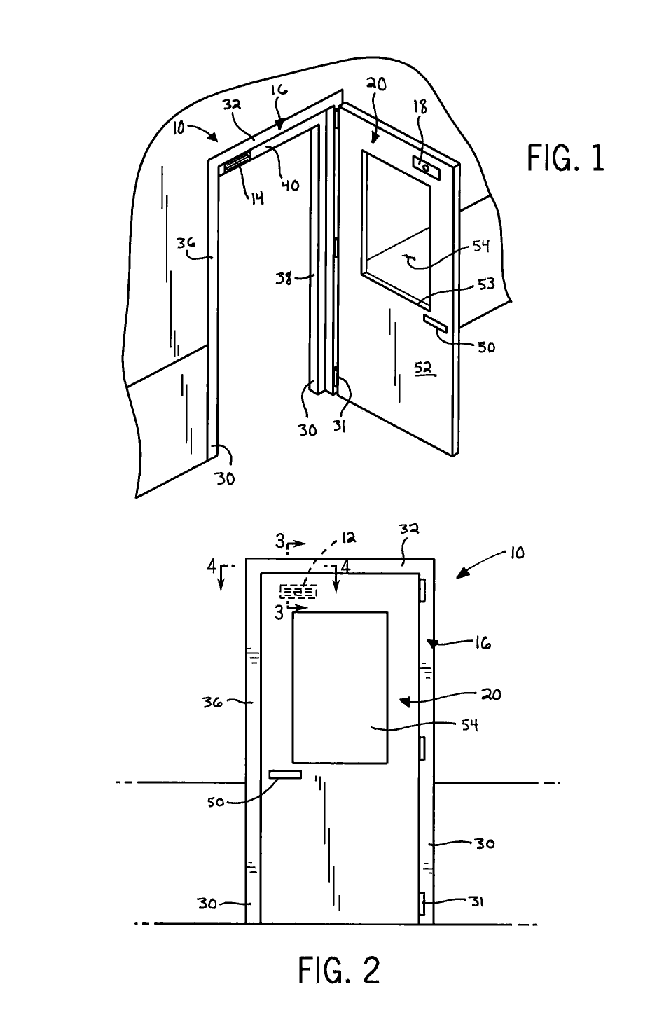

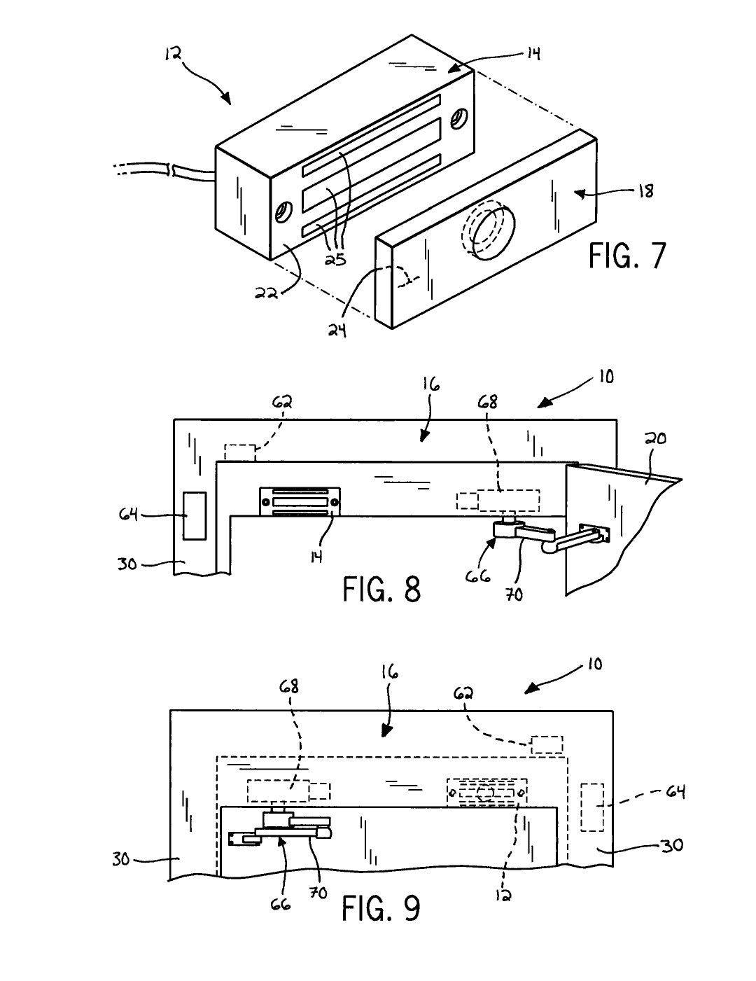

Referring to FIGS. 1-7, the present invention provides a doorway 10 that includes a magnetic lock 12 that has an electromagnet 14 mounted within the door jamb 16. The electromagnet 14 is electrically energized by a power source (not shown) to provide a magnetic force that attracts a striker plate or armature 18 mounted within the door 20. When the door 20 is closed and the electromagnet 14 is energized, the electromagnet 14 holds the armature 18 thereto, thereby securing the doorway 10. These components and their interactions are described in further detail in the following paragraphs, beginning with the magnetic lock 12 and then proceeding to the jamb 16 and the door 20.

Still referring to FIGS. 1-7, the electromagnet 14 and the armature 18 of the magnetic lock 12 include exposed faces 22 and 24, respectively, that abuttingly engage one another when the door 20 is closed. In this context, the term “abuttingly engage” should be understood in contrast to shearly engaging or shear-type magnetic locks that face vertically; that is, the exposed face 22 of the electromagnet 14 faces a direction in which individuals may pass through the doorway 10, and the exposed face 24 of the armature 18 faces the opposite direction when the door 20 is closed. Unlike shear-type magnetic locks, the magnetic lock 12 does not include grooves in which dust can collect. The exposed face 22 of the electromagnet 14 may include upper electromagnet core surfaces 25 defined by E-shaped electromagnet core laminations. The electromagnet 14 and the armature 18 also include holes through which fasteners 26 and 28 pass to secure the components to the jamb 16 and the door 20, respectively.

The armature 18 is preferably about 6½″ long, 1⅝″ tall, and ½″ wide. The electromagnet 14 is preferably about 8″ long, 1¾″ tall, 1½″ wide and may require about 3.6 W of power. Thus, the electromagnet 14 draws about 300 mA when powered by a 12VDC source and 150 mA when powered by a 24VDC source. The magnetic lock 12 as described above preferably provides a holding force of about 600 lbs. An appropriate magnetic lock design for these dimensions and specifications is model M32 manufactured by Securitron Magnalock Corporation of Sparks, Nev., although other designs may also be used.

Referring now to FIGS. 1-5, the door jamb 16 includes two vertical spans 30, one of which includes a hinge 31 that connects to the door 20, and an upper horizontal span 32 connecting the vertical spans 30. Each of the spans 30 and 32 are preferably hollow components that have welded sheet metal surfaces, such as 16-gauge 304-#4 stainless steel surfaces. Other materials may also be used to form the surfaces of the spans 30 and 32, such as fiberglass and the like. The overall size of the jamb 16 may vary depending on the application in which the doorway 10 is used. In an exemplary embodiment, the vertical spans 30 are about 2⅝″ long and 6″ wide, and the horizontal span 32 is about 4⅝″ high and 6″ wide.

The spans 30 and 32 define a front section 36 that surrounds the door 20 when closed. The spans 30 and 32 also define a recessed inner section 38 and a stop surface 40 against which the door 20 closes. The stop surface 40 may be recessed from the surface of the front section 36 by about 1 15/16″. It is also contemplated that the interface between the door 20 and the stop surface 40 may include seals, flexible stoppers, or the like; in this context, a statement of the door 20 engaging the stop surface 40 should be understood to be open to these alternatives.

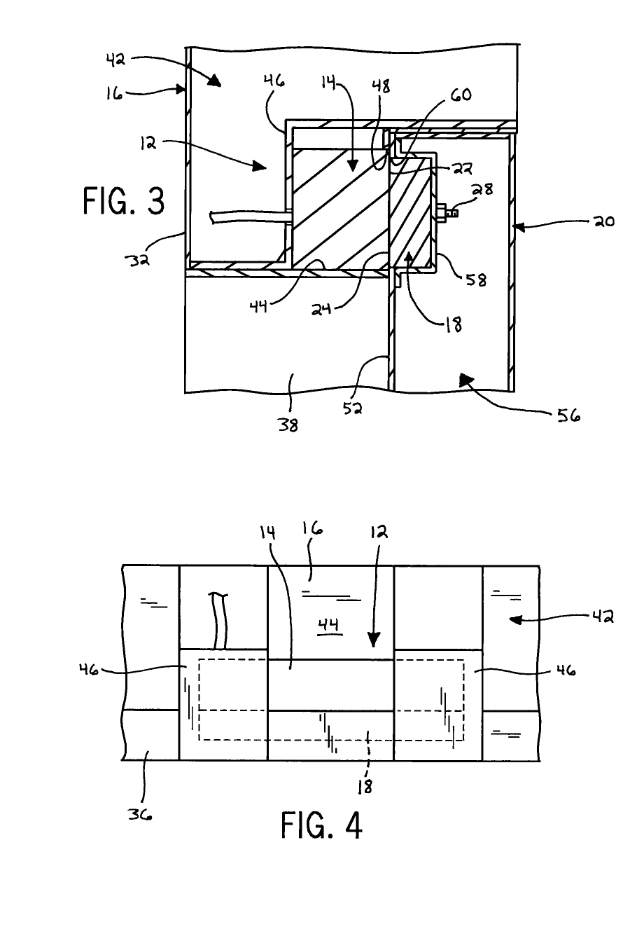

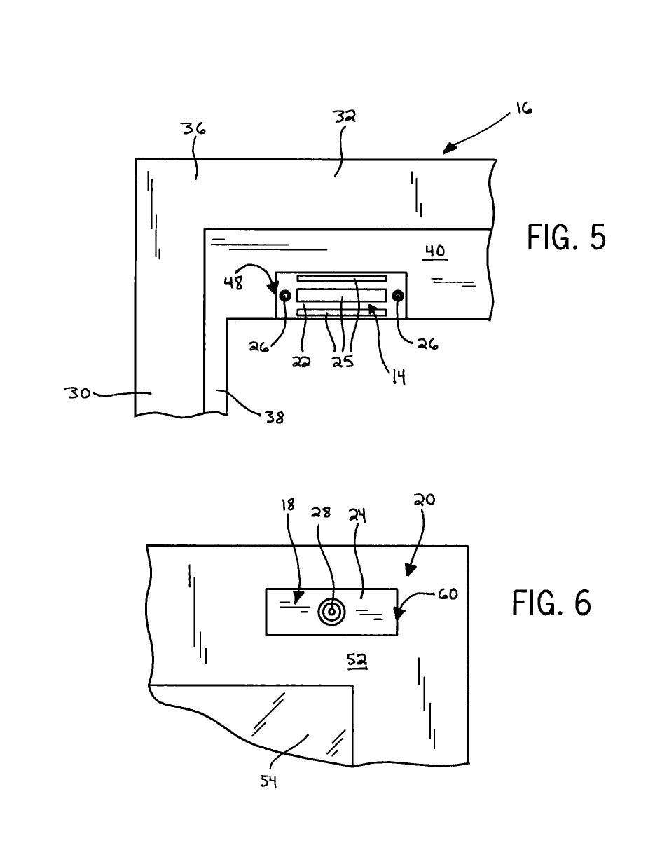

As described briefly above, the spans 30 and 32 are preferably hollow components; in addition, the upper span 32 defines an interior jamb space 42 (FIGS. 3 and 4) that accommodates the electromagnet 14. A lower surface 44 of the upper span 32 supports the electromagnet 14 and two brackets 46 within the space 42 secure the electromagnet 14 to the span 32. The brackets 46 may be welded to the upper span 32 and connected to the fasteners 26, in an exemplary embodiment, by ¼-20 threaded fastener mounts. The electromagnet 14 and the brackets 46 are disposed in the space 42 proximate an opening 48 (FIGS. 3 and 5) defined by the stop surface 40; the exposed face 22 of the electromagnet 14 is preferably disposed in the opening 48 and flushly aligned with the stop surface 40. The upper span 32 may house one or more shims (not shown) between the electromagnet 14 and the brackets 46 to ensure the exposed face 22 is properly oriented relative to the stop surface 40. Alternatively, the exposed face 22 may be slightly recessed in the interior jamb space 42. In any case, the exposed face 22 is the face of the electromagnet 14 nearest to the exterior of the doorway 10.

From the previous paragraphs it should be apparent that the upper span 32 and the brackets 46 advantageously protect the electromagnet 14 from being struck and moved from an appropriate position. This construction also advantageously provides a jamb 16 that is easy to clean because the electromagnet 14 does not form any horizontal ledges.

Referring now to FIGS. 1-4 and 6, the door 20 includes a handle 50, a front surface 52 that engages the stop surface 40 of the jamb 16, and, in some embodiments, a rabbet 53 that supports a window 54. The door 20 is also preferably a hollow component that has sheet metal surfaces, such as 16-gauge 304-#4 stainless steel surfaces. Other materials may also be used to form the surfaces of the door 20, such as fiberglass and the like. The overall size of the door 20 may vary depending on the size of the jamb 16. In an exemplary embodiment, the door 20 is about 1¾″ wide.

The door 20 defines an interior door space 56 (FIG. 3) that accommodates the armature 18. A bracket 58 supports the armature 18 within the space 56, and the bracket 58 may be welded and/or connected to the door 20 via the fastener 28. In an exemplary embodiment, the bracket 58 provides a pocket for the armature 18 that is ¾″ deep. The armature 18 and the bracket 58 are disposed in the space 56 proximate an opening 60 (FIGS. 3 and 6) defined by the front surface 52, and the exposed face 24 of the armature 18 is preferably disposed in the opening 60 and flushly aligned with the front surface 52. Alternatively, the exposed face 24 may be slightly recessed in the interior door space 56. In either case, the exposed face 24 is the face of the armature 18 nearest the exterior of the doorway 10. This construction advantageously provides a door 20 that is easy to clean because the armature 18 does not form any horizontal ledges.

Referring now to FIGS. 8 and 9, in some embodiments the doorway 10 includes several additional components. For example, the doorway 10 may include a position switch 62 that monitors whether the door 20 is open or closed. The position switch 62 may be connected to a control circuit (not shown) within or outside the jamb 16 so that security personnel can monitor the status of the door 20. The position switch 62 may be any appropriate design known to those skilled in the art. As another example, the doorway 10 may include light emitting diodes 64 that indicate if it is permissible to pass through the doorway 10. The light emitting diodes 64 may also connect to the control circuit. The light emitting diodes 64 may be any appropriate designs known to those skilled in the art. The doorway 10 may also include other components known to those skilled in the art, such as keypads and/or card readers (not shown) that control operation of the magnetic lock 12, gang electrical boxes (not shown), and the like. In any case, the wiring that connects these components to the magnetic lock 12 and/or the control circuit is advantageously concealed in the jamb 16 to prevent tampering and contact with objects passing through the doorway 10.

As another example, in some embodiments the edges and bottom of the door 20 include seals (not shown) and a sweep (not shown), respectively, that permit the doorway 10 to be used in certain applications, such as life science laboratories. Appropriate seal and sweep designs will be recognized by those skilled in the art.

As yet another example, the doorway 10 may include a concealed closer 66 that closes the door 20 after being opened. The closer 66 includes a housing 68 disposed within the interior jamb space 42 that drives an arm assembly 70 to close the door 20; the housing 68 and the arm assembly 70 are preferably configured to permit a maximum door swing of 90 to 105 degrees. The closer 66 is also preferably disposed near the vertical span 30 connected to the hinge 31 and the magnetic lock 12 is near the other vertical span 30. Appropriate closer designs are those from the 5010 series manufactured by LCN Closers of Princeton, Ill., although other designs may also be used.

From the above disclosure it should be apparent that the doorway of the present invention includes a jamb and a door that are designed for use with a magnetic lock. In addition, the magnetic lock is preferably assembled to the jamb and the door before installation of the doorway. As a result, the amount of labor needed to install the doorway is reduced. For example, the jamb, door, and hinge do not need to be mounted with high accuracy because the magnetic lock components are pre-mounted. As another example, accurate holes do not need to be marked and drilled to attach the lock to the doorway. It should also be apparent that the doorway of the present invention advantageously provides a ledge-free structure for easy cleaning and an inconspicuous design that prevents tampering and contact with objects passing through the doorway.

A preferred embodiment of the invention has been described in considerable detail. Many modifications and variations to the preferred embodiment described will be apparent to a person of ordinary skill in the art. Therefore, the invention should not be limited to the embodiment described, but should be defined by the claims that follow.

We claim:

1. A doorway, comprising:
a jamb defining an interior jamb space and including:
a stop surface defining a jamb opening between the interior jamb space and an exterior space;
an electromagnet operable to provide an attractive magnetic force housed within the interior jamb space;
a door pivotally connected to the jamb to open and close the doorway and defining an interior door space, the door including:
a front surface defining a door opening between the interior door space and the exterior space; and
a magnetically attractive armature housed within the interior door space being abuttingly engagable with the electromagnet when the doorway is closed.

2. The doorway of claim 1, wherein the electromagnet includes an exposed face nearest the exterior space, and the exposed face is one of disposed in the interior jamb space and flush with the stop surface.

3. The doorway of claim 1, wherein the armature includes an exposed face nearest the exterior space, and the exposed face is one of disposed in the interior door space and flush with the front surface.

4. The doorway of claim 3, wherein the electromagnet includes an exposed face nearest the exterior space, and the exposed face is one of disposed in the interior jamb space and flush with the stop surface.

5. The doorway of claim 1, further comprising at least one bracket connecting the electromagnet and the jamb within the interior jamb space.

6. The doorway of claim 1, wherein the jamb further includes two vertical spans and an upper horizontal span connecting the vertical spans and defining the interior jamb space.

7. The doorway of claim 6, further comprising a closer configured to hold the door closed and including a housing disposed within the upper horizontal span and a pivotable arm assembly connecting the housing and the door.

8. The doorway of claim 7, further comprising a hinge connecting a first of the vertical spans and the door, the closer being disposed proximate the first of the vertical spans and the electromagnet being disposed proximate the other of the vertical spans.

9. The doorway of claim 1, further comprising a closer configured to hold the door closed and including a housing disposed within the jamb and a pivotable arm assembly connecting the housing and the door.

10. The doorway of claim 1, wherein the jamb and the door comprise sheet metal surfaces.

11. A doorway, comprising:
a jamb including a stop surface;
an electromagnet housed within the jamb operable to provide an attractive magnetic force and including an exposed face being one of recessed in the jamb and flush with the stop surface;
a door pivotally connected to the jamb to open and close the doorway and including a front surface being engagable with the stop surface to close the doorway; and
a magnetically attractive armature housed within the door and including an exposed face being abuttingly engagable with the electromagnet when the doorway is closed, the exposed face being one of recessed in the door and flush with the front surface.

12. The doorway of claim 11, wherein the jamb includes a front section surrounding the door when the doorway is closed, the front section including a front surface, and the stop surface being recessed from the front surface of the front section.

13. The doorway of claim 11, further comprising a bracket disposed within the door supporting the armature.

14. The doorway of claim 11, further comprising at least one bracket disposed within the jamb connecting the electromagnet and the jamb.

15. The doorway of claim 11, wherein the jamb and the door comprise sheet metal surfaces.

16. A doorway, comprising:
a jamb defining an interior jamb space and including a stop surface defining a jamb opening between the interior jamb space and an exterior space;
a door pivotally connected to the jamb to open and close the doorway and defining an interior door space, the door including a front surface being engagable with the stop surface to close the doorway, the front surface defining a door opening between the interior door space and the exterior space;
a magnetic lock including:
an electromagnet disposed within the interior jamb space operable to provide an attractive magnetic force and including an exposed face nearest the exterior space facing a direction in which individuals pass through the doorway, the exposed face being one of recessed in the interior jamb space and flush with the stop surface; and
a magnetically attractive armature disposed within the interior door space configured to engage the electromagnet and including an exposed face nearest the exterior space facing opposite the direction faced by the electromagnet when the doorway is closed, the exposed face of the armature being one of recessed in the interior door space and flush with the front surface.

17. The doorway of claim 16, wherein the jamb includes an upper span housing the electromagnet.

18. The doorway of claim 17, further comprising at least one step-shaped bracket disposed within the upper span connecting the electromagnet and the jamb.

19. The doorway of claim 18, further comprising a bracket disposed within the interior door space supporting the armature.

20. The doorway of claim 16, wherein the jamb includes a front section surrounding the door when the doorway is closed, the front section including a front surface, and the stop surface being recessed from the front surface of the front section.
